(19) United States
(12) Patent Application Publication
(10) Pub. No.: US 2007/0061774 A1
(43) Pub. Date: Mar. 15, 2007

(54) APPARATUS, SYSTEM, AND METHOD FOR MANAGING PROJECT CUSTOMIZATION, COMPLIANCE DOCUMENTATION, AND COMMUNICATION

(76) Inventors: Jonathan Chan, Niskayuna, NY (US); Benjamin Chan, Niskayuna, NY (US); Robert G. Metler, Woodland Hills, UT (US); Timothy E. Metler, Springville, UT (US); Nicholas G. Pasto, Orem, UT (US)

Correspondence Address: KUNZLER & ASSOCIATES, 8 EAST BROADWAY, SUITE 600, SALT LAKE CITY, UT, 84111, US

(21) Appl. No.: 11/530,845

(22) Filed: Sep. 11, 2006

Related U.S. Application Data
(63) Continuation-in-part of application No. 11/344,876, filed on Feb. 1, 2006.
(60) Provisional application No. 60/715,755, filed on Sep. 9, 2005.

(51) Int. Cl. G06F 9/44

(52) U.S. Cl. 717/101; 717/163; 717/104; 717/103; 717/120

(57) ABSTRACT

An apparatus, system, and method are disclosed for managing construction projects. The present invention may include an option library module configured to provide a set of building options defined by a general contractor. The invention may also include an option set library module configured to allow a general contractor to define subsets of options from the option library module, the subsets of options organized into custom categories configured for selection of a single option by a customer. Additionally, the invention may include a room library module configured to allow the general contractor to define one or more room structures that the general contractor can associate with the one or more subsets of options, the room structure comprising an organizational unit representing a location related to a specific project or project template. Advantageously, this allows a general contractor to manage complex project customization without requiring programming knowledge.

### CROSS-REFERENCES TO RELATED APPLICATIONS

This application claims benefit of U.S. Provisional Patent Application No. 60/715,755 entitled “Apparatus, System, and Method for Managing Project Customization, Compliance, Documentation, and Communication” and filed on Sep. 9, 2005 for Jonathan Chan, et al., which is incorporated herein by reference and is a continuation in part of U.S. patent application Ser. No. 11/344,876 entitled “Apparatus, System, and Method for Project Bidding and Scheduling” and filed on Feb. 1, 2006 for Jonathan Chan, et al., which is incorporated herein by reference.

### BACKGROUND OF THE INVENTION

1. Field of the Invention

This invention relates to project management and more particularly relates to managing project customization, compliance documentation, and communication.

2. Description of the Related Art

The field of project management covers a wide range of industries. For example, the fields of residential building, commercial construction, product manufacturing, building and product design, software design, and the like require project management to perform efficiently. Typically, projects require detailed management of schedule, costs, labor, material, and the like to achieve this efficiency. Additionally, project work is often contracted out to general contractors or trade subcontractors, which requires additional bidding management.

Traditionally, customization of projects can be costly and difficult to manage. Also some builders desire different levels of customization for different projects and lack the tools necessary to efficiently vary the level of customization. As a result, custom builders have difficulty managing tract projects, and tract builders lack the flexibility to manage custom projects. Tract projects typically comprise multiple building projects selected from a relatively small set of building plans with minimal variation between projects. Custom projects however may each include a unique building design as well as a variety of differences that the end customer may make or choose in defining the custom building project.

Builders also face difficulty tracking compliance of subcontractors with various regulatory and insurance requirements, such as workman's compensation, liability insurance, bonding, and licensing. The difficulty in tracking these compliance documents often prevents a builder from establishing that workers on a job site are appropriately licensed, insured, and bonded. As a result, the insurance rates for the builder are increased to cover the possibility of non-compliant workers.

In addition, builders include products such as appliances, fixtures, and building products from many original equipment manufacturers (OEMs) in their projects. Generally, customers must later establish independent relationships with these OEMs to communicate about these products regarding warranty, repair, and use. This communication is valuable to both customers and OEMs, but it is often impeded by the costs associated with establishing communication.

A need exists for an apparatus, system, and method for managing project customization, compliance documentation, and communication. Beneficially, such an apparatus, system, and method would dynamically integrate tools for efficient customization, tools that collect and record compliance documentation, and tools that facilitate communication between customers and OEMs more efficiently than current project management tools allow.

### SUMMARY OF THE INVENTION

The present invention has been developed in response to the present state of the art, and in particular, in response to the problems and needs in the art that have not yet been fully solved by currently available project managers. Accordingly, the present invention has been developed to provide an apparatus, system, and method for managing project customization, compliance documentation, and communication that overcome many or all of the above-discussed shortcomings in the art.

The apparatus to manage construction projects is provided with a plurality of modules configured to functionally execute the necessary steps of managing construction projects. These modules in the described embodiments include an option library module configured to provide a set of building options defined by a general contractor. The apparatus may also include an option set library module configured to allow a general contractor to define subsets of options from the option library module, the subsets of options organized into custom categories configured for selection of a single option by a customer. Further, the apparatus may include a room library module configured to allow the general contractor to define one or more room structures that the general contractor can associate with the one or more subsets of options, the room structure comprising an organizational unit representing a location related to a specific project or project template.

The room library module in the apparatus, in one embodiment, is further configured to allow a customer to define a room structure and associate one or more options with the user-defined room structure. In another embodiment, the apparatus further includes a project options module configured to allow a user to selectively define one or more options that are capable of being incorporated into one of the option library module, the specific project, and a custom project. The subsets of options, in one embodiment, are further organized into one or more folders containing one or more similar types of subsets of options.

The apparatus is further configured, in one embodiment, such that a subset of options is assignable to a plurality of rooms. In another embodiment, the subsets of options are modifiable by the general contractor. In a further embodiment, the apparatus is configured to allow a plurality of general contractors to access the option library module, the option set library module, and the room library module. The apparatus, in another embodiment, is configured to generate a spec sheet template in response to the selection of one or more room structures to be included in a construction project.

A computer program product for managing construction projects is also provided. The computer program product, in one embodiment, may comprise a computer useable medium having a computer readable program, wherein the computer readable program when executed on a computer causes the computer to perform the steps necessary for managing construction projects. In one embodiment, the processes of the computer program product may include presenting a set of building options defined by a general contractor through an option library module. The processes of the computer program product may also include defining subsets of options from the option library module through an option set library module, in response to input from a general contractor, the subsets of options organized into custom categories configured for selection of a single option by a customer. The processes of the computer program product may further include defining one or more room structures that the general contractor can associate with one or more subsets of options with each room structure through a room library module, in response to input from a general contractor, the room structure comprising an organizational unit representing a location related to a specific project or project template. The computer program product may further include providing information about the project to a customer and receive input relating to the project from the customer through a customer interface module.

In one embodiment, the computer program product may further include a view/manage warranty information module configured to receive warranty information relating to a building option from one of an original equipment manufacturer (OEM) and a general contractor and provide the warranty information to the customer through the customer interface module. In another embodiment, the view/manage warranty information module in the computer program product may be configured to receive information from an OEM through a live feed. The customer interface module in the computer program product, in one embodiment, may be configured to allow a customer to select options to be incorporated into the project.

In another embodiment, the computer program product may be further configured such that a value is assigned to options and the aggregate value of selected options is restricted to not exceed the allowance. The customer interface module in the computer program product, in one embodiment, may be configured to receive a change request from the customer and transmit the request to a general contractor.

An apparatus of the present invention is also presented for project bidding and scheduling. The apparatus may be embodied by a plurality of modules configured to functionally execute the necessary steps of project bidding and scheduling. These modules in the described embodiments include a project workflow module configured to define a general workflow for a project available for bidding, a bidding module configured to select a proposed bid submitted in response to a request for bids associated with the project, a job management module configured to modify the project workflow in accordance with the specifications of the selected bid, a scheduling module configured to continuously adapt the workflow in response to project changes arising during the course of the project lifecycle, and a trade contractor interface module configured to present information about the project to a trade contractor and receive input relating to the project from the trade contractor.

The apparatus may further include a compliance management module configured to receive and store compliance information and documentation from the trade contractor. In another embodiment, the trade contractor interface in the apparatus is further configured to present information and receive input relating to a plurality of jobs from a trade contractor.

A method of the present invention is also presented for managing construction projects. The method in the disclosed embodiments substantially includes the steps necessary to carry out the functions presented above with respect to the operation of the described apparatus and system. In one embodiment, the method includes organizing similar types of options for a construction project into an option set comprising one or more options such that any one of the options from the option set can be selected for use in a part of the construction project, assigning an option set to a room to define the possible options for the room, the room comprising an organizational unit representing a location related to a specific project or project template, and generating a spec sheet that defines a building project in response to the assignment of one or more rooms to the spec sheet.

In a further embodiment, the method includes generating a spec sheet template that defines a building project in response to the assignment of one or more rooms to the spec sheet template. In another embodiment, the method includes allowing a customer to select options from the option set assigned to the room to specify the option to be used in a construction project.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for project bidding and scheduling;

FIG. 2 is a schematic block diagram illustrating one embodiment of an apparatus for project bidding and scheduling;

FIG. 3 is a schematic block diagram illustrating one embodiment of an apparatus for an application interface module;

FIG. 4 is a schematic block diagram illustrating one embodiment of an apparatus for a customer interface module;

FIG. 5 is a schematic block diagram illustrating one embodiment of an apparatus for an trade contractor interface module;

FIG. 6 is a schematic block diagram illustrating one embodiment of an apparatus for a library module;

FIG. 7 is a schematic block diagram illustrating a relationship between option sets and rooms; and

FIG. 8 is a schematic flow chart diagram illustrating one embodiment of a method for creating a project spec sheet.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Some basic features of a project bidding and scheduling apparatus, system, and method are described in co-owned U.S. patent application Ser. No. 60/649,309, filed Feb. 1, 2005, which is herein incorporated by reference.

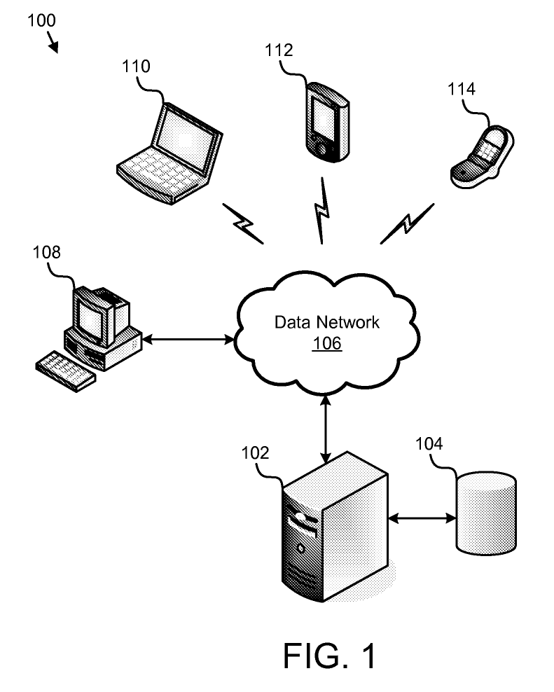

FIG. 1 is a schematic block diagram illustrating one embodiment of a system 100 for project bidding and scheduling. In one embodiment, the system 100 includes a server 102 in communication with a database 104, and one or more server clients. In another embodiment, the server client is a workstation 108 connected to the server 102 through a data network 106. Additionally, the system 100 may include one or more server clients wirelessly connected to the server 102. For example, a server client may include a laptop computer 110, a Personal Digital Assistant (PDA) 112, and a cellular telephone 114.

In one embodiment, the server 102 provides application services, web services, mail services, data storage services, and communication services, wherein the services are utilized to support operations of the invention described herein. Additionally, the server 102 may host an apparatus, software application, or the like to perform certain operations of the disclosed invention. In one embodiment, a single server 102 may provide some or all of theses services. Alternatively, a plurality of servers 102 may be connected and perform these services individually.

In one embodiment, the database 104 stores data for use by the server 102. The database 104 (and associated database management system) may be remote to the server 102. Alternatively, the database 104 may reside on the server 102. The database 104 may include a storage controller, data storage devices such as magnetic or optical storage disks, data input/output (I/O) controls, and the like. In one embodiment, the database 104 employs Structured Query Language (SQL) for data handling and other database related operations. The database management system may comprise a hierarchical or relational database including, but not limited to MySQL, IMS™, DB2™, SQL server™, Microsoft Access™, Oracle™, and the like.

In one embodiment, the server 102 may include a software application for project bidding and scheduling. Preferably, the software application remains on the server 102 where the clients use common thin-client software such as a web browser to interact with the software application. Alternatively, or in addition, components of the application may be distributed for use via a data network 106. Data is also exchanged over the data network 106. In one embodiment, a data network 106 includes a Local Area Network (LAN). Alternatively, a data network 106 may include a wireless LAN, a Wide Area Network (WAN), the internet, a cellular data communication network, a Very Small Aperture Terminal (VSAT) or other network, and the like.

In one embodiment, the server clients may access an application, apparatus, service, or the like hosted by the server 102. The server 102 may provide full or limited access for the clients on a full or limited rights basis, wherein the rights are determined by predefined user policies. The client may include a work station 108, a laptop computer 110, a PDA 112, a cellular telephone 114, or the like. For example, a workstation 108 may be used for intra-office access to the server 102. A laptop computer 110, or PDA 112 may be used to remotely access the server 102. Additionally, a cellular telephone 114 or pager with text messaging services may be used communicate information with the server 102.

For example, the cellular telephone 114 may receive a text message from a building management application hosted by the server 102 indicating a schedule change. The recipient may then use a PDA 112 to view the details of the schedule change. In one embodiment, the user may additionally initiate schedule changes from the PDA 112 or cellular telephone 114. Alternatively, the user may access the building application with the laptop computer 110 or the workstation 108.

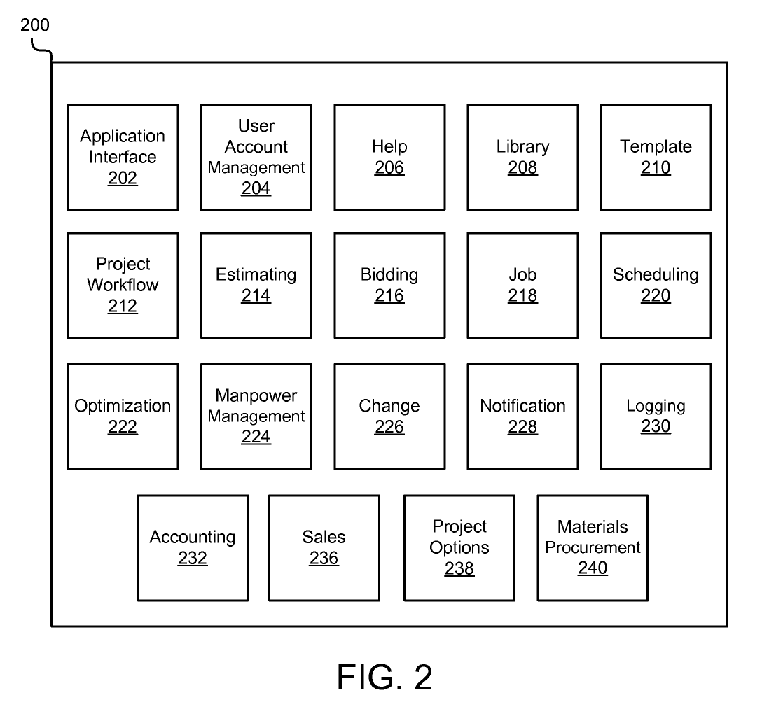

FIG. 2 is a schematic block diagram illustrating one embodiment of an apparatus 200 for project bidding and scheduling. In one embodiment, the apparatus 200 includes several framework modules configured to provide operational support for functional modules. In one embodiment, the framework modules include an application interface module 202, a user account management module 204, a help module 206, a library module 208, and a template module 210. Additionally, the apparatus 200 may include functional modules for performing specific project bidding and scheduling functions. These modules may include a project workflow module 212, an estimating module 214, a bidding module 216, a job module 218, a scheduling module 220, an optimization module 222, a manpower management module 224, a change module 226, a notification module 228, and a logging module 230. The apparatus 200 may additionally include an accounting module 232, a sales module 236, a project options module 238, and a materials procurement module 240.

In one embodiment, the application interface module 202 is configured to provide a user interface to the functional modules of the apparatus 200. In one embodiment, the user interface is web based. For example, a user may request access to the apparatus 200. The application interface 202 may then provide a web browser based user interface using Hyper Text Transfer Protocol (HTTP). Alternatively, the application interface module 202 may provide a Graphical User Interface (GUI), a command line interface, a voice activated interface, or the like.

Additionally, the application interface module 202 may provide security and access control for certain modules. For example, if a user attempts to access the accounting module 232, the application interface module 202 may provide encrypted access to the accounting module 232. The application interface module may employ Secure Socket Layer (SSL) or Secure HTTP (S-HTTP) encryption to secure data transmissions between the user and the requested module.

In one embodiment, the user account management module 204 may provide access for the clients to the functional modules of the apparatus 200 on a full or limited rights basis, wherein the rights are determined by predefined user policies. In one embodiment, the user policies are determined by permissions set for individual user authentication information. In one embodiment, user authentication information includes a username and password. Alternatively, the user policies are determined by the type of client accessing the server 102. For example, if the server 102 hosts a building project application, the server 102 may grant full access to a general contractor accessing the application via a workstation 108. Alternatively, the server 102 may grant restricted access to a subcontractor accessing the application via a PDA 112. In such an example, the user policy may be determined by either the authentication information of the users, or by the physical device attempting to access the server. In one embodiment, the access rights include addition, modification, and deletion of data, schedule items, projects, jobs, and the like.

In one embodiment, the help module 206 provides operation information to a user accessing the apparatus 200. For example, the help module 206 may provide a general tutorial on standard operation of each module. Alternatively, the help module 206 may provide context specific help to a user of a particular module. For example, a user attempting to operate the estimating module 214 may require help to create a job estimate. In one embodiment, the help module 206 may include a popup help menu to provide estimation specific information. In an alternative embodiment, the user may search a help database for estimation specific information.

In one embodiment, the library module 208 contains a library of information, data objects, software components, or the like, each used for operation of the apparatus 200. In one embodiment, the library may contain a plurality of application specific templates. For example, a user may access the bidding module 216 to create a for a particular job. The user may be able to pull a job template generally describing the particular job from the library module 208, and modify the template for the specifics of a particular bid. In another embodiment, the library module 208 may contain user and/or job resource information. For example, the library 208 may contain searchable information associated with electrical contractors capable of performing a particular job. In one embodiment, the library module 208 utilizes the database 104 as a data repository to store templates, information, and the like.

In one embodiment, the template module 210 provides a modifiable framework for various tasks performed by the apparatus 200. The templates may provide a standardized data format to enable dynamic and automatic management of a project. In one embodiment, a template is a file or other structure containing general information used as a framework to create a specific file or object. For example, a user may create a project workflow file for a particular project based on a project workflow template stored in the library module 208. The project workflow may define a set of steps organized into a particular order and associated with a time line for completing a project. In one embodiment, the template module 210 may provide a graphical interface to access structures, such as file icons, folder icons, illustrative blocks logically representing an object or step in a process, and the like. Additionally, the template module 210 may provide basic information for a given task. For example, the template for bidding a framing project may include placeholders for information commonly present in framing bids such as hours of labor, lumber costs, nail costs, and other costs commonly associated with construction framing bids. As used herein, the template may also be referred to as a “spec sheet template” or “spec. sheet template” which means that the spec sheet template is a template for a specifications (spec) sheet which can then be used to build a particular project.

In one embodiment, the project workflow module 212 provides functionality such as general project management, job creation and management, and contractor management, and the like. In one embodiment, the project workflow module 212 may incorporate a project workflow template provided by the template module 210 for a specific task. The project workflow template may provide a basic framework for management of the particular project, and specific details may be added to the template in the project workflow module 212 to create a comprehensive project overview and management utility.

For example, a home builder may have a template defined for a home building project. When the home builder starts a home building project, he/she may load a new home building project template from the template module 210 into the project workflow module 212. The home building project template may include a rough workflow diagram including steps generally required for home building such as concrete work, framing, sheet rocking, plumbing, electrical, roofing, and the like. In one embodiment, the home builder may add specific trade contractors and their associated schedules and costs to the project workflow module 212. The project workflow module 212 then creates a graphical workflow diagram, an estimated cost, and estimated building schedule.

In one embodiment, the estimating module 214 is configured to assist in job cost and schedule estimating. The estimating module 214 may comprise a drawing viewer, a scaling tool, a measurement tool, calculators, and the like. Additionally, job specification templates may be loaded from the template module 210 to further assist in job estimation.

For example, a flooring contractor may create an estimate to lay tile flooring in a kitchen of a home using the estimating module 214. The flooring contractor may load the blueprint plans (in a secure format) for the home in the drawing view, load a flooring job spec. sheet template from the template module 210, and set the drawing scale using the scaling tool. Then, the flooring contractor may enter a cost per unit square foot into a cost calculator based on the material and labor costs defined in a job spec. sheet or defined by the flooring contractor. Then, the flooring contractor may use a pointer to select or define a shape associated with the perimeter of the kitchen floor area on the floor plan. The estimating module 214 may then calculate the total selected square footage, and the associated cost. Additionally, the calculators may calculate volumes and other measurements related to concrete volumes, electrical requirements, ventilation systems, and the like.

In one embodiment, the estimating module 214 may additionally allow modifications to be made to the building plans. The modifications may be made by overlaying multiple drawing layers on the plan drawings. For example, a redline drawing may comprise a drawing layer and a redline layer. Additionally, the estimating module 214 may allow overlay of multiple objects on the drawing using a stamping tool. For example, an electrical contractor may stamp a symbol representing an electrical outlet, light switch, light fixture, or the like. In one embodiment, the estimating module 214 may calculate a cost based on the number of objects stamped onto the drawing.

In one embodiment, the bidding module 216 is configured to prepare and submit bids for jobs made available for bid by a requestor. In one embodiment, the bidding module 216 may load a bidding template from the template module 210. In one embodiment, the bidding template is prepared by a general contractor, project manager, or other job bid requester. The bidding module 216 may then incorporate details from the estimate specification sheet prepared in the estimation module 214 into the bid. Alternatively, the user may fill in details required by the bidding template with a user interface. In one embodiment, a bid may include details such as material costs, labor costs, schedules, and the like. Multiple bids may be submitted to a requester in response to a request for bid. In one embodiment, a winning bid may be manually selected by a user. Alternatively, the winning bid may be selected or proposed by a project optimization algorithm described in relation to the optimization module 222.

In one embodiment, the job module 218 provides management of individual jobs within the project. The job module 218 may provide a user interface for job schedule management, materials procurement, trade contractor management, and the like. In one embodiment, the job module 218 may be utilized to create a request for bids associated with a particular job. Additionally, the job module 218 may automatically update job information when a job bid is selected.

For example, a general contractor may use the job module 218 to create a job for plumbing a new residential building. The general contractor may load a plumbing job template created by the template module 210, and create a request for bids on the plumbing job based on the plumbing job template. One or more plumbing trade contractors may then submit bids created using the bidding module 216. The general contractor may then select a plumbing contractor based on the submitted bids. In one embodiment, the general contractor may then update the job information using the job module 218. For example, the general contractor may drag an icon representing the plumbing contractor bid using a mouse or similar computer component, and drop the icon over an icon representing the plumbing job in the job module 218. In one embodiment, the job module 218 may be incorporated with the project workflow module 212. The job module 218 may then automatically update the job schedule information, cost information, trade contractor information, and materials information based on the details of the job bid.

In one embodiment, the scheduling module 220 provides scheduling details for a project, job, work crew, customer, and the like. The scheduling module 220 may include a schedule flow diagram. Alternatively, the scheduling module 220 may include a Gantt chart. In another embodiment, the schedule may include a text or spreadsheet correlation between dates and tasks to be accomplished. For example, the scheduling module 220 may be integrated with the project workflow module 212 to determine an overall project schedule. In such an example, the scheduling module 220 may provide an interactive schedule flow diagram. In another example, the scheduling module 220 may be integrated with the job module 218 to manage a work crew schedule. The scheduling module 220 may provide a Gantt chart representing the work schedule of multiple jobs to be performed by the work crew. Such a schedule may be beneficial in job planning, and identification of potential schedule delays or conflicts. In one embodiment, the scheduling module 220 may provide a standalone schedule display illustrating a personal daily work schedule, a project specific work schedule, a project progress schedule, and the like.

In one embodiment, the optimization module 222 may provide schedule and cost optimization for the project. In one embodiment, the optimization module 222 may implement a scheduling or cost optimization algorithm. The optimization algorithm may take into account factors such as weekends, holidays, scheduling conflicts, order of job priority, job prerequisites, hard deadlines, vacation days, and the like. The optimization algorithm may also account for backordered materials, market cost of materials, overtime costs vs. schedule benefits, and other cost and scheduling factors. The optimization module 222 may use these factors along with a standard deterministic, stochastic, or other computational optimization algorithm identifiable by one possessing ordinary skill in the art of computational optimization algorithms.

In one embodiment, the manpower management module 224 may be used in coordination with the scheduling module 220 to manage work crews. In one embodiment, the manpower management module 224 may identify possible scheduling conflicts. The manpower management module 224 may additionally update and change scheduling information related to manpower management. In one embodiment, the manpower management module 224 maintains a Gantt chart of work crew jobs and dates. Additionally, the manpower management module 224 may identify potential manpower shortages, make adjustments to account for unplanned manpower shortages, and the like.

For example, building contractors often contract with a trade contractor to work on several homes simultaneously, or within a relatively narrow window of time. For instance, a general contractor may contract with a framing contractor to frame ten homes within a two month period. With a high volume of work and a narrow time schedule, efficient manpower management becomes critically important. If the framing contractor knows that it takes a minimum of a five man framing crew to frame a home within a five day period, the framing contractor may load that information into the manpower management module 224. The manpower management module 224 may then use a Gantt chart to illustrate the framing crew's work schedule in relation to the individual homes to be framed. The manpower management module 224, and the optimization module 222 may account for job delays, holidays, weekends, and vacations to determine the most efficient framing schedule, the number of framing crews required to accomplish the job on time, and the like.

In one embodiment, the change module 226 is configured to modify the project schedule. The change module 226 may be loaded by a trade contractor to request a schedule change. Additionally, the change module 226 may be loaded by a general contractor using a PDA 112 in the field to make a schedule change. In one embodiment, the change module 226 may receive a text message from a cellular telephone or pager requesting a schedule change. The change module 226 may additionally approve or reject a schedule change request. The change module 226 may shift scheduled events in accordance with approved requested changes. Additionally, the change module 226 may use the optimization module 222 to optimize the schedule shift resulting from a schedule change.

In one embodiment, the notification module 228 may send update information to users of the apparatus 200. The notification module 228 may notify users of schedule changes, project updates, and the like using email, cellular network text messaging, an intra-system messaging system, synthesized voice messages, and the like. For example, in response to a schedule change, the notification module 228 may send an email to all contractors impacted by the schedule change. Additionally, the notification module 228 may send a text message to the cellular telephone 114 of the individual contractors affected. The contractors may then check their email using a PDA 112, laptop computer 110, or workstation 108. Preferably, such notifications are provided asynchronously such that the notified users need not be immediately accessible when the notification is sent. In this manner, routine and regular job schedule adjustments can be made while minimizing the time and availability requirements conventionally associated with job schedule changes.

Furthermore, in one embodiment, the notification module 228 is configured to send the notifications at predefined times in relation to when the change is made. Notifications may be sent immediately or within a certain time period prior to when the change affects a user. For example, a delay in a concrete pour may be sent to the concrete finishing crew one week prior to the originally scheduled date rather than the date the change was made which may be one to two months ahead of the originally scheduled date.

In one embodiment, the logging module 230 logs activities performed by the apparatus 200. The logging module 230 may log some or all activities according to a logging policy. The logging module 230 may store the activity logs on the database 104. For example, the logging module 230 may log the specifics of a particular schedule change, including the user originally requesting the change, the user approving the change, and a list of users notified of the change. Activity logs may be used for auditing changes made as well as permitting changed to be undone at a later date, if needed.

In one embodiment, the accounting module 232 performs bookkeeping, cost accounting, financial planning, and the like. The accounting module 232 may perform such tasks automatically, or in response to user controls. A general contractor accounting module 232 may prepare and itemized listing of all work done and materials used to build a home. For example, a subcontractor accounting module 232 may automatically generate and send an invoice for a job to a general contractor in response to completion of the project.

In one embodiment, the sales module 236 may provide sales assistance to project sales representatives. For example, the sales module 236 may include access to the estimating module 214 to provide total project cost estimating and or projection completion timing information for a customer. Additionally, the sales module 236 may provide automatic project selection features to a customer. For example, a sales module 236, used by a home builder, may allow customers to view pricing and schedule estimates for multiple floor plans. In such an example, the customer may be able to tailor the project to their needs prior to starting the project. Additionally, the sales module 236 may provide access to sales brochures, contractor profiles, and the like.

In one embodiment, the project options module 238 allows a customer, sales person, or contractor to select special building options. The building options selected using the project options module 238 may be incorporated in the overall project workflow. Additionally the project options module 238 may be used to streamline materials procurement. For example, a customer purchasing a custom home may use the project options module 238 to select the color and style of carpet to install in the home. The building options selected by the customer may be automatically logged and ordered. Preferably, building options are selected from a predefined subset of options referred to herein as an options set.

In one embodiment, the project options module 238 may selectively allow a customer to define options that are not defined in the available option sets presented in the project options module 238. The user-defined options are preferably configured so that the options can be incorporated into one of the options library or a custom project for the customer. In this manner, the customer can add special options that are unknown or anticipated by the general contractor. However, these user-defined options may still include a price markup defined by the general contractor. Furthermore, the general contractor interface 302 permits the general contractor to decide whether defining of user-defined options will be allowed for a particular customer. This provides significant flexibility for the general contractor and minimizes the negotiations that traditionally occur as a customer decides to add or remove customizations. In addition, because user-defined options have the same format as general contractor defined options, a general contractor can optionally add the user-defined option to the options library 602 (see below) for subsequent use in an options set.

In one embodiment, the materials procurement module 240 assists in materials procurement. The materials procurement module 240 may automatically order materials in accordance with the project schedule and specification sheet. Alternatively, a user may use the materials procurement module 240 to order materials from a supplier. In one embodiment, a preferred supplier may have access to the materials procurement module 240 for receiving orders. For example, the materials procurement module 240 may automatically order enough sheetrock to cover the walls of a home building project one week before the sheet rocking crew is scheduled to work on the project. The sheetrock supplier may receive a notification from the notification module 228 that the builder has submitted an order.

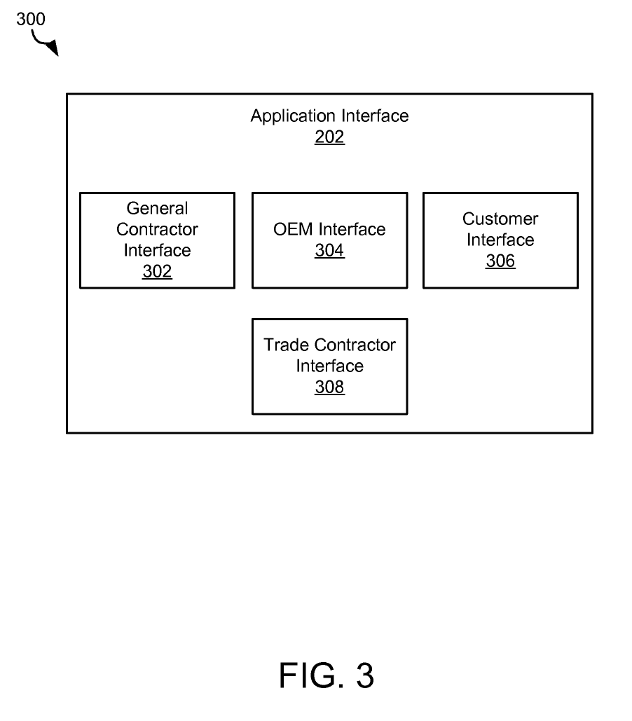

FIG. 3 is a schematic block diagram illustrating one embodiment of an apparatus 300 for an application interface module 202 for providing user access to the project bidding and scheduling tool 200. In one embodiment, the application interface module 202 may include a general contractor interface module 302, an original equipment manufacturer (OEM) interface module 304, a customer interface module 306, and a trade contractor interface module 308. In one embodiment, the interface modules may provide tailored access to modules of the apparatus 200 based on which interface is used. The interface module 202 may operate within or cooperate with a conventional software interface such as a web browser, a custom made software application interface, or other similar hardware or software devices.

In one embodiment, the general contractor interface module 302 allows the general contractor to access the modules of the apparatus 200. The general contractor interface module 302 may allow the general contractor to access substantially all of the modules of the apparatus 200. In one embodiment, the general contractor interface module 302 may allow the general contractor to set permissions for the other interfaces 304-308. In another embodiment, the general contractor interface module 302 may allow the general contractor to preview the other interfaces 304-308 based on the permissions set by the general contractor for those other user interfaces 304-308.

In one embodiment, the general contractor interface module 302 may allow the general contractor to communicate with other users of the apparatus 200. These communications may include change requests, licensing documents, bid submission responses, and the like. These communications may be logged and recorded by the apparatus 200. The general contractor interface module 302, in one embodiment, preferably allows the general contractor to view all of the communications related to a project.

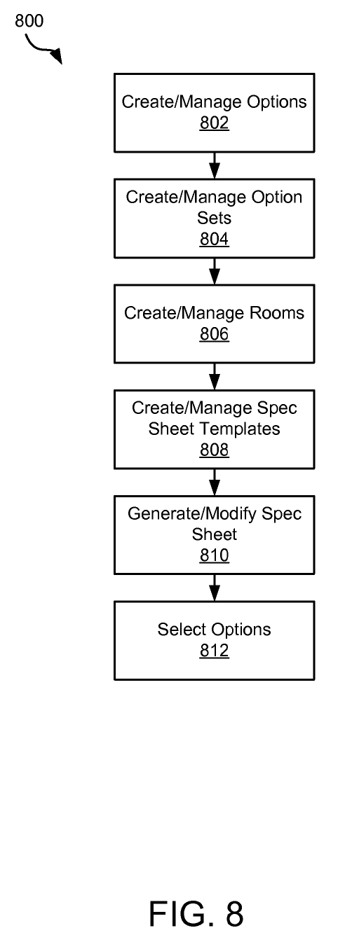

In one embodiment, the general contractor interface module 302 allows the general contractor to set allowances for a project. An allowance defines preset expense levels allocated for a customer to use to select options for a project, as discussed in more detail below in relation to FIG. 8. In one embodiment, as a customer selects options, the apparatus 200 may track the aggregate cost of those options and may prevent the selection of additional options that would cause the total cost to exceed the allowance.

The OEM interface module 304, in one embodiment, allows submission of information from an OEM to the apparatus 200. OEM information may include cost, retail price, dimensions, weight, shipping costs, options, warranty information, product description, one or more product illustrations, and the like.

In one embodiment, the OEM interface module 304 may receive information from a live feed such as a rich site summary (RSS) feed, an extensible markup language (XML) document, or the like. A live feed is a source of information available in response to a request from the OEM interface module 304. Alternatively, the live feed provides information dynamically to the OEM interface module 304 as the OEM changes the relevant data. The live feed may be maintained by the OEM, by the general contractor, or by a third party. The live feed may provide updated information about OEM products to the apparatus 200 to allow for better planning and decision making in the planning process.

In an alternate embodiment, the OEM interface module 304 may allow manual submission of OEM information. The OEM, or a third party may manually provide information about OEM products to the apparatus 200 through the OEM interface module 304. Optionally, the general contractor may manually provide information about OEM products to the apparatus 200 through the OEM interface module 304 or the general contractor interface module 302. The OEM interface module 304 may comprise a web browser interface. In another embodiment, the OEM interface module 304 may comprise a custom application interface.

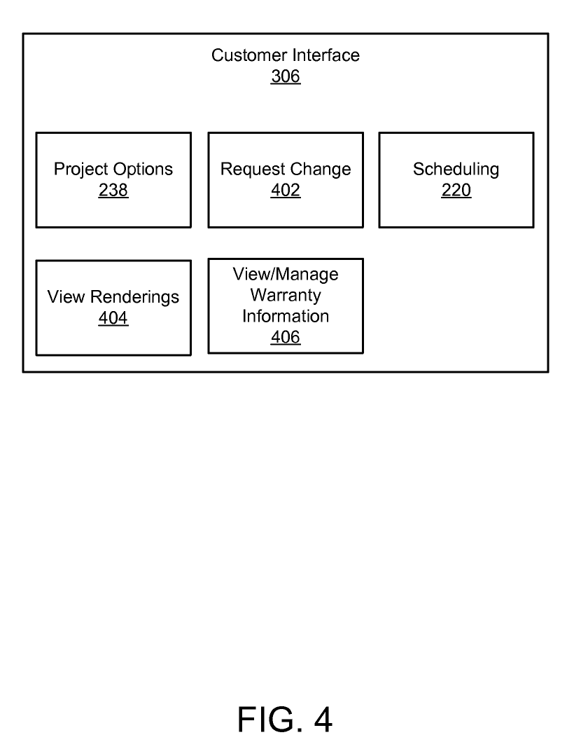

The customer interface module 306, in one embodiment, allows a customer to interact with the apparatus 200. The customer may interact with the apparatus 200 through the customer interface module 306 while planning the project, while the project is being constructed, and after the project is completed. In one embodiment, the customer interface module 306 may comprise a web browser interface. In another embodiment, the customer interface module 306 may comprise a custom built application interface. Embodiments of the customer interface module 306 are described in greater detail in relation to FIG. 4.

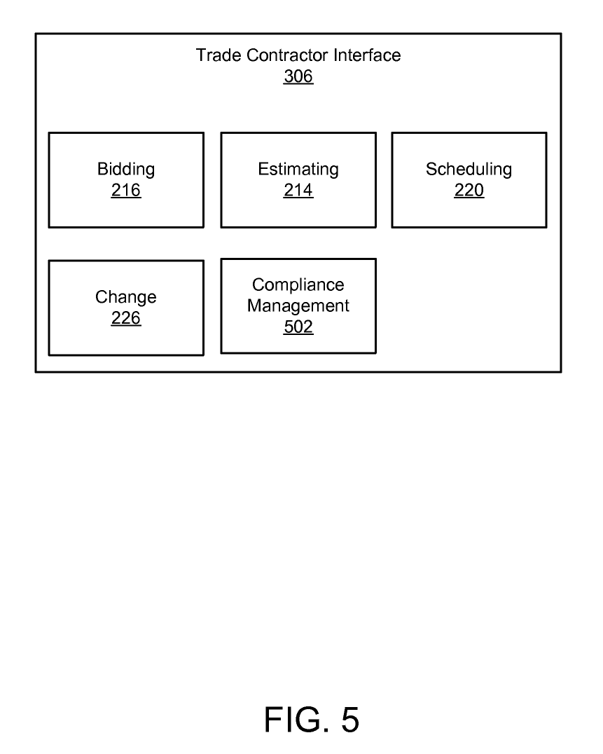

The trade contractor interface module 308, in one embodiment, allows a trade contractor to interact with the apparatus 200. The trade contractor may interact with the apparatus 200 through the trade contractor interface module 308 during the bidding phase of the project, while the project is being constructed, and after the project is completed. In one embodiment, the trade contractor interface module 308 may comprise a web browser interface. In another embodiment, the trade contractor interface module 308 may comprise a custom built software application interface. Embodiments of the trade contractor interface module 308 are described in more detail in relation to FIG. 5.

FIG. 4 illustrates one embodiment of an apparatus for a customer interface module 306. The customer interface module 306 may include a project options module 238, a request change module 402, a scheduling module 220, a view renderings module 404, and a view/manage warranty information module 406. In one embodiment, the customer interface module 306 allows a customer to interact with the apparatus 200.

The project options module 226, in one embodiment, allows the customer to select among options provided by the apparatus 200. In one embodiment, the project options module 238 allows a customer to select special building options. The building options selected using the project options module 238 may be incorporated in the overall project workflow. For example, a customer purchasing a custom or tract home may use the project options module 238 to select the color and style of carpet to install in the home.

In one embodiment, the project options module 226 may include a finalization function. The customer may select and modify building options in the project options module 226 until the finalization function finalizes the building options. Once the finalization function is invoked, building options cannot be selected or modified without processing a change request through the change module 226.

The request change module 402, in one embodiment, allows a customer to request changes in the project. In one embodiment, the customer may use the request change module 402 to request changes in finalized building options. After the change request is submitted through the request change module 402, the general contractor may approve or reject the change. For example, the customer may decide to change from a top load clothes washer to a front load clothes washer after the building options have been finalized. The customer may submit a change request through the request change module 402. The general contractor may then approve or reject the change in clothes washer selection. The general contractor may also impose a change fee to be associated with the change.

The scheduling module 220, in one embodiment, provides scheduling details for a project, job, and the like. The general contractor may allow the customer access to portions of the schedule through the scheduling module 220 of the customer interface 306. In one embodiment, the general contractor may allow the customer to access schedules for specific project milestones that may be updated as the project proceeds. In another embodiment, the general contractor may select a time window of the project schedule during which the customer may be allowed to access certain details of the project, job, or the like. For example, the contractor may allow access to a weekly schedule of work associated with the project.

The scheduling module 220 may include a schedule flow diagram. Alternatively, the scheduling module 220 may include a Gantt chart. In another embodiment, the schedule may include a text or spreadsheet correlation between dates and tasks to be accomplished. For example, the scheduling module 220 may be integrated with the project workflow module 212 to determine an overall project schedule. In such an example, the scheduling module 220 may provide an interactive schedule flow diagram. In one embodiment, the scheduling module 220 may provide a standalone schedule display illustrating a daily work schedule, a project specific work schedule, a project progress schedule, and the like all personalized for a particular project.

The view renderings module 404, in one embodiment, allows the customer view rendered images of the project based on selections made in the project options module 238 and/or the progress of the project. The view renderings module 404 may allow views from multiple viewpoints, angles, and lighting conditions. For example, the customer may select paint and carpet for a portion of a project and view a rendered image that reflects the selected paint and carpet within that portion of the project. Additionally, the user may view rendered or actual digital images of the project at different stages in the progress of the project.

The view/manage warranty information module 406, in one embodiment, allows the customer to access warranty information relating to building options. In one embodiment, the warranty information is provided by the OEM through the OEM interface 304. The customer may view the warranty information through the view/manage warranty information module 406. In another embodiment, the customer may manage warranty information through the view/manage warranty information module 406. For example, the customer may view warranty information relating to a particular dryer selected in the project options module 238. The view/manage warranty information module 406 may also generate a form to submit warranty registration information to the OEM for the customer. The view/manage warranty information module 406 may also allow the customer to submit a warranty claim to the OEM or a general contractor. Preferably, the view/manage warranty information module 406 allows a customer to print out or store copies of the warranty information as needed.

FIG. 5 illustrates one embodiment of an apparatus for a trade contractor interface module 306. The trade contractor interface module 306 may include a bidding module 216, an estimating module 214, a scheduling module 220, a change module 226, and a compliance management module 502.

In one embodiment, the bidding module 216 is configured to allow a trade contractor to prepare and submit bids for jobs made available for bid by the general contractor. In one embodiment, the bidding module 216 may load a bidding template from the template module 210. In one embodiment, the bidding template is prepared by a general contractor, project manager, or other job bid requestor. The bidding module 216 may then incorporate details from the estimate specification sheet prepared in the estimation module 214 into the bid. Alternatively, the trade contractor may fill in details required by the bidding template with the trade contractor interface module 306. In one embodiment, a bid may include details such as material costs, labor costs, schedules, and the like. Multiple bids may be submitted to a requester in response to a request for bid.

In one embodiment, the bidding module 216 is configured to allow the trade contractor to manage bids submitted through the trade contractor interface module 306. The trade contractor may be allowed to withdraw or modify bids that have not been accepted by the general contractor. In one embodiment, the trade contractor may view bids currently submitted by the trade contractor. The trade contractor may also be allowed to view the status of the bids submitted by the trade contractor, including open bids, rejected bids, accepted bids, and the like.

In one embodiment, the estimating module 214 is configured to assist the trade contractor in job cost and schedule estimating. The estimating module 214 may comprise a drawing viewer, a scaling tool, a measurement tool, calculators, and the like. Additionally, job specification templates may be loaded from the template module 210 to further assist in job estimation.

For example, a flooring contractor may create an estimate to lay tile flooring in a kitchen of a home using the estimating module 214. The flooring contractor may load the blueprint plans (in a secure format) for the home in the drawing view, load a flooring job spec. sheet template from the template module 210, and set the drawing scale using the scaling tool. Then, the flooring contractor may enter a cost per unit square foot into a cost calculator based on the material and labor costs defined in a job spec. sheet or defined by the flooring contractor. Then, the flooring contractor may use a pointer to select or define a shape associated with the perimeter of the kitchen floor area on the floor plan. The estimating module 214 may then calculate the total selected square footage, and the associated cost. Additionally, the calculators may calculate volumes and other measurements related to concrete volumes, electrical requirements, ventilation systems, and the like.

In one embodiment, the scheduling module 220 allows the trade contractor to view scheduling details for a project, job, work crew, and the like. The scheduling module 220 may include a schedule flow diagram. Alternatively, the scheduling module 220 may include a Gantt chart. In another embodiment, the schedule may include a text or spreadsheet correlation between dates and tasks to be accomplished. For example, the scheduling module 220 may be integrated with the project workflow module 212 to determine an overall project schedule.

In such an example, the scheduling module 220 may provide an interactive schedule flow diagram. In another example, the scheduling module 220 may be integrated with the job module 218 to manage a work crew schedule. The scheduling module 220 may provide a Gantt chart representing the work schedule of multiple jobs to be performed by the work crew. Such a schedule may be beneficial in job planning, and identification of potential schedule delays or conflicts. In one embodiment, the scheduling module 220 may provide a standalone schedule display illustrating a personal daily work schedule, a project specific work schedule, a project progress schedule, and the like. For example, the trade contractor may be awarded a bid for a job and view the schedule for that job through the trade contractor interface module 306.

In one embodiment, the change module 226 is configured to modify the project schedule. The change module 226 may be loaded by a trade contractor to request a schedule change. Requested schedule changes may require the approval of the general contractor.

In one embodiment, the change module 226 may also be configured to allow the trade contractor to view changes made by others to the project that impact the schedule of the trade contractor. For example, a change that delays the completion of a foundation may be relayed to the framing contractor by the change module 226. Thus, adjustments can be made to account for such delays.

The compliance management module 502, in one embodiment, may be configured to receive and store compliance information and documentation. Compliance documentation may include licensing information, liability insurance information, bond information, workman's compensation, and the like. By requiring submission of compliance information and documentation by trade contractors to the apparatus 200, the general contractor can ensure and prove compliance with regulations and underwriter requirements. Managing of compliance information and documentation may enable the general contractor to secure lower insurance rates.

In one embodiment, the compliance management module 502 may receive compliance documents as a scanned image, such as a pdf file, a jpeg file, or the like. In another embodiment, the compliance management module 502 may be configured to allow a trade contractor to enter data relating to compliance information and documentation, such as dates of expiration of licenses, liability insurance policy numbers, and the like.

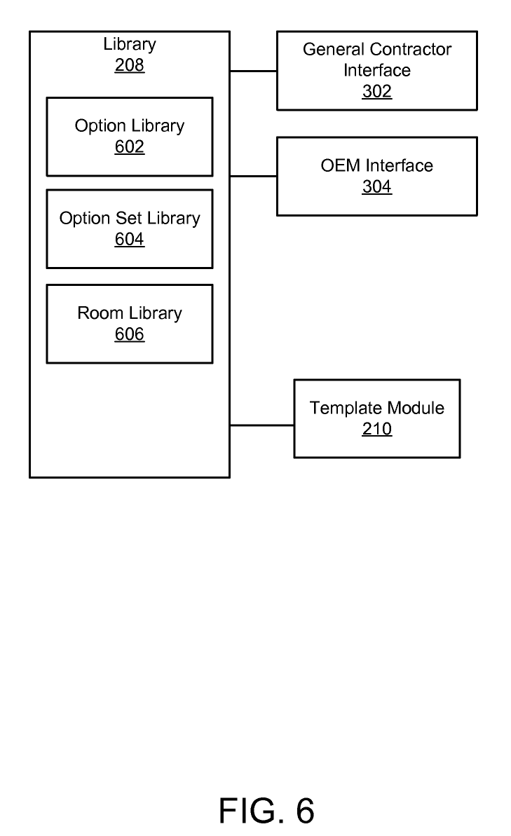

FIG. 6 illustrates one embodiment of an apparatus for a library module 208. The library module 208 may include an option library module 602, an option set library module 604, and a room library module 606. The library module 208 may contain a library of information, data objects, software components, templates, or the like, each used for operation of the apparatus 200.

The option library module 602, in one embodiment, may contain information about options that may be used in a building project. Each option in the option library module 602 may include information such as brand name, model number, color, dimensions, warranty information, a photograph, or the like. An example of an option is a Frigidaire™ model 2100 refrigerator, white on white, including a front view photo and a side view photo. Additional images may be included in an option as well as a general text description of the option.

In one embodiment, the options in the option library module 602 may be created, deleted, and/or modified by the general contractor through the general contractor interface module 302 as described in relation to FIG. 3. In another embodiment, the options in the option library module 602 may also be created, deleted, and/or modified by the OEM through the OEM interface module 304 as described in relation to FIG. 3. In yet another embodiment, the options in the option library module 602 may also be created, deleted, and/or modified by the customer through the user interface module 306 as described in relation to FIG. 3. The options may be manually input and updated. In an alternate embodiment, the options may be dynamically updated through a feed, such as an XML document, an RSS feed, a web service, or the like. Advantageously, dynamic updating of the options facilitates and accommodates OEM changes without increase time and expense that is conventionally required to update the options information. For example, an OEM price change to one item can readily be fed to the options set library module 604 such that the change is effective for each new selection of an option associated with the price change. Options selected by a customer prior to the price change may be unaffected by the price change.

The option set library module 604, in one embodiment, may contain a collection of one or more option sets. An option set may comprise a combination of one or more similar items selected from the options in the option library module 602. For example, an option set entitled “trim paint set 1” may include “green,” “red,” and “chartreuse.” Preferably, a customer is allowed to select only one option from each defined option set. In one embodiment, each option set includes one default option that will be used if a customer does not make a change to the option set by selecting a different option. The default option in certain embodiments may be defined by the general contractor using the general contractor interface 302.

In one embodiment, the option sets may include links to one or more options in the option library module 602. The links form an association with the one or more options such that a modification to an option in the option library module 602 results in a corresponding modification to the option available in the option set in the option set library module 604. For example, the contractor may modify the brand of refrigerator offered as one option in an appliances option set replacing Amana® with Whirpool®. The links allow for each option set that includes this particular refrigerator option to automatically include the brand change.

In another embodiment, a general contractor can enable a modification to an option set such that the option set may include one or more options that are not linked to an option in the option library module 602. The options in the option set are then not linked to corresponding options in the option library module 602. Since the one or more options in the option set are independent from the option library module 602, a user may modify options or add custom options that impact the current project only, and do not change option sets that appear in other projects. For example, a customer may request a brand of refrigerator that is not included in the option set. The general contractor may enable a modification to the option set to include the requested brand for that customer only, so that the requesting customer may select the requested brand of refrigerator, but other customers cannot.

In one embodiment, the option sets in the option set library module 604 may be grouped by category. For example, the option set library module 604 may include a folder entitled “paint” containing an option set entitled “trim paint set 1” and an option set entitled “wall paint set 1.”

In one embodiment, the option sets in the option set library module 604 may be created, deleted, and/or modified by the general contractor through the general contractor interface module 302 as described in relation to FIG. 3. The option sets may be manually or dynamically updated through a feed, such as an XML document, an RSS feed, a web service, or the like. For example, certain options such as a particular make and model of a clothes washer may be discontinued. Consequently, the next dynamic options update from the particular OEM may not include that clothes washer. Accordingly, the option set(s) that originally included the discontinued clothes washer may be changed to no longer include the discontinued clothes washer.

The room library module 606, in one embodiment, may contain a collection of one or more room structures. A room structure may be an organizational unit representing a specific or general physical or conceptual location. For example, a room structure may be “kitchen,” “yard,” “bedroom 1,” “above the washer,” “under the kitchen sink,” “the patio,” “the side yard,” or the like.

In one embodiment, a room structure in the room library module 606 may include one or more associated option sets from the option set library 604. For example, a room structure entitled “bedroom 1” may include “trim paint set 1,” “wall paint set 1,” “carpet set 1,” and “fixtures set 2.” An option set may be associated with more than one room structure in one embodiment. For example, “trim paint set 1” may be associated with “bedroom 1” and “kitchen 1.” In one embodiment, the general contractor can add, delete, and/or modify the option sets associated with a room structure through the general contractor interface module 302.

The template module 210, in one embodiment, may contain a collection of one or more spec sheet templates that include one or more room structures from the room library module 606. Alternatively or in addition, the spec sheet templates may include one or more categories. The spec sheet template (organized by room, by category or a combination of these) may also include one or more option sets from the option set library module 604. For example, a spec sheet template may include “bedroom 1,” “bedroom 2,” “bathroom 1,” “kitchen 4,” “living room 2,” “dining room 1,” “garage 2,” and“yard 1.”

A spec sheet template, in one embodiment, may be converted into a spec sheet by the general contractor. The spec sheet may then include specific data and selections for a particular building project. The spec sheet may be further modified by the general contractor by adding, modifying, and/or deleting room structures. Added room structures may originate from the room library module 606 and/or added option sets may originate from the option set library module 604. A customer may then select an option from each option set defined in the spec sheet. The general contractor may put jobs out for bid to trade contractors from the spec sheet.

The interaction between libraries 602-606 allows a general contractor to quickly create spec sheets for different types of structures and manage the completion of those structures efficiently. For example, since the general contractor can build an extensive set of libraries 602-606 in the apparatus 200, the general contractor may use the apparatus 200 in building tract homes using a relatively small number of option sets, and the general contractor may use the apparatus 200 in building custom homes using a relatively large number of option sets. The flexibility of the apparatus 200 allows the general contractor to utilize one tool for tract home construction and custom home construction, reducing the costs for the general contractors associated with custom home construction.

Conventionally, general contractors that wanted to offer custom building projects and tract building projects had to use two different techniques. For tract building projects a relatively small set of options were made available to a customer through a “design center.” This resulted in reduced management complexity for the general contractor because the numbers of options were limited and well defined. In contrast, to support custom building projects, the general contractor might maintain lists of numerous OEMs, trade contractors, and suppliers that a customer could use in defining a very large almost endless number of options that the customer might choose. The large provider and options lists, large number of choices, and maintenance of the selections made increased the management complexity dramatically and made custom building projects almost intractable. As a consequence, most builders opted to provide either tract building project services or custom building project services.

Advantageously, the apparatus 200 allows a general contractor to readily provide tract building project services and custom building project services using the same tool. The options are readily defined and updated in the options library 602. The option sets are easy to define and maintain to organize the options. The room library 606 permits the option sets to be organized in relation to a particular building project regardless of whether the project is a tract building project or a custom building project. In addition, the application interface 202, in certain embodiments, may allow a customer or general contractor to define additional rooms that permit a customer to add as much customization as desired. The general contractor may then define the option sets available for that newly defined room. As a result, one general contractor can readily offer tract building project services and custom building project services with reduced management complexity and provide an appealing experience for the customer.

In addition, the apparatus 200 can be used by a plurality of general contractors. Each general contractor's spec sheet templates, options library 602, and option set library 604 can be unique and tailored to the particular general contractor. In certain embodiments, the apparatus 200 may include sample spec sheet templates, options libraries 602, and option set libraries 604. Alternatively, general contractors may share spec sheet templates, options libraries 602, and option set libraries 604 with each other using the general contractor interface 302.

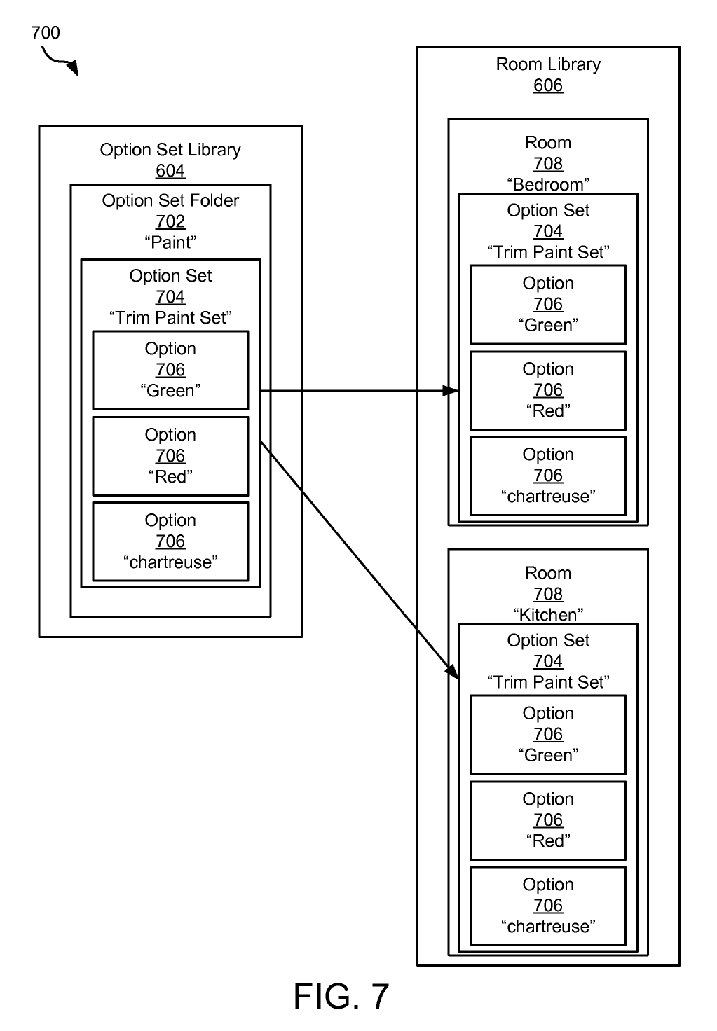

FIG. 7 illustrates one embodiment of an apparatus 700 including a relationship between option sets 704 in an option set library 604 to rooms 708 within a room library 606. The apparatus 700 may include an option set library 604, a room 606, zero or more option set folders 702, one or more option sets 704, and one or more rooms 708. The chart of FIG. 7 illustrates that one option set 704 can be used in many different rooms. Preferably, any change to the single option set 704 (“trim paint set” for example) is reflected in the different rooms 708 defined in the room library 606. The option set library 604 and the room library 606 are preferably configured in a similar manner to like numbered elements discussed in relation to FIG. 6. Advantageously, the association between option sets and rooms simplifies the task of defining and modifying a building project, thus allowing a general contractor with limited computer experience to create and manage a building project.

FIG. 8 illustrates a schematic flow chart diagram of one embodiment of a method 800 for managing construction. Initially, a general contractor creates or manages 802 options in an option library 602. Each option may include information about the option, such as color, brand, model, cost, size, layout, design, and the like. The general contractor may add, modify, and/or delete options in the option library 602. In an alternate embodiment, a trusted third party, such as an OEM, a trade contractor, and/or a supplier may create/manage 802 options in the option library 602.

Next, the general contractor may create and/or manage 804 option sets. Options sets include one or more options from the option library 602 arranged by category, such as paint, plumbing fixtures, cabinets, and the like. Each category may include one or more option sets, and each option may appear in any number of option sets. The general contractor may add, modify, and/or delete option sets in the option set library 604. In an alternate embodiment, a trusted third party may create/manage 804 option sets.

Next, the general contractor may create/manage rooms 806. The general contractor may associate one or more option sets from the option set library 604 with a room. Each room may include one or more option sets, and each option set may appear in any number of rooms. The general contractor may add, modify, and/or delete rooms in the room library 606. In an alternate embodiment, a trusted third party may create/manage 806 rooms.

Next, the general contractor may create/manage 808 spec sheet templates. Spec sheet templates may include one or more job specifications organized by category, one or more option sets from the option set library 604, and one or more rooms from the room library 606. The general contractor may add, modify, and/or delete spec sheet templates in the spec sheet template library 608. In an alternate embodiment, a trusted third party may create/manage 808 spec sheet templates.

Next, the general contractor may generate/modify 810 a spec sheet. A spec sheet is generated from a spec sheet template. The spec sheet may then be modified without impacting the spec sheet template. By modifying a spec sheet, the general contractor can create a custom building project with relative ease.

Next, the customer may select 812 options. In one embodiment, the options available for selection may be generated from the spec sheet, and the available options may be organized into categories, option sets, and/or rooms. In certain embodiments, the customer may also define additional rooms to further customize the building project. The customer or general contractor may then associate one or more option sets with the newly defined room. Alternatively, the customer may define one or more options for the newly defined room. In this manner, flexibility and additional customizations are provided.

In one embodiment, the selection 812 may be constrained by an allowance. The allowance may include a maximum dollar value for selections in a category. For example, a “flooring” category may have an allowance of $10,000, and the apparatus 200 may require the customer to select options from the flooring category that have a combined cost of less than or equal to $10,000.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for managing construction projects, the apparatus comprising:
an option library module configured to provide a set of building options defined by a general contractor;
an option set library module configured to allow a general contractor to define subsets of options from the option library module, the subsets of options organized into custom categories configured for selection of a single option by a customer; and
a room library module configured to allow the general contractor to define one or more room structures that the general contractor can associate with the one or more subsets of options, the room structure comprising an organizational unit representing a location related to a specific project or project template.

2. The apparatus of claim 1, wherein the room library module is further configured to allow a customer to define a room structure and associate one or more options with the user-defined room structure.

3. The apparatus of claim 1 further comprising a project options module configured to allow a user to selectively define one or more options that are capable of being incorporated into one of the option library module, the specific project, and a custom project.

4. The apparatus of claim 1 wherein the subsets of options are further organized into one or more folders containing one or more similar types of subsets of options.

5. The apparatus of claim 1 wherein a subset of options is assignable to a plurality of room structures.

6. The apparatus of claim 1 wherein the subsets of options are modifiable by the general contractor.

7. The apparatus of claim 1 further configured to allow a plurality of general contractors to access the option library module, the option set library module, and the room library module.

8. The apparatus of claim 1 further configured to generate a spec sheet template in response to the selection of one or more room structures to be included in a construction project.

9. A computer program product for managing construction projects, the computer program product comprising a computer useable medium having a computer readable program, wherein the computer readable program when executed on a computer causes the computer to:
present a set of building options defined by a general contractor through an option library module;
define subsets of options from the option library module through an option set library module, in response to input from a general contractor, the subsets of options organized into custom categories configured for selection of a single option by a customer; and
define one or more room structures that the general contractor can associate with one or more subsets of options with each room structure through a room library module, in response to input from a general contractor, the room structure comprising an organizational unit representing a location related to a specific project or project template; and
provide information about the project to a customer and receive input relating to the project from the customer through a customer interface module.

10. The computer program product of claim 9 further comprising a view/manage warranty information module configured to receive warranty information relating to a building option from one of an original equipment manufacturer (OEM) and a general contractor and provide the warranty information to the customer through the customer interface module.

11. The computer program product of claim 10 wherein the view/manage warranty information module is further configured to receive information from an OEM through a live feed.

12. The computer program product of claim 9 wherein the customer interface module is further configured to allow a customer to select options to be incorporated into the project.

13. The computer program product of claim 12 wherein a value is assigned to options and the aggregate value of selected options is restricted to not exceed the allowance.

14. The computer program product of claim 9 wherein the customer interface module is further configured to receive a change request from the customer and transmit the request to a general contractor.

15. An apparatus for project bidding and scheduling, the apparatus comprising:
a project workflow module configured to define a general workflow for a project available for bidding;
a bidding module configured to select a proposed bid submitted in response to a request for bids associated with the project;
a job module configured to modify the project workflow in accordance with the specifications of the selected bid;
a scheduling module configured to continuously adapt the workflow in response to project changes arising during the course of the project lifecycle; and
a trade contractor interface module configured to present information about the project to a trade contractor and receive input relating to the project from the trade contractor.

16. The apparatus of claim 15 further comprising a compliance management module configured to receive and store compliance information and documentation from the trade contractor.

17. The apparatus of claim 15 wherein the trade contractor interface is further configured to present information and receive input relating to a plurality of jobs from a trade contractor.

18. A method for managing construction projects, the method comprising:
organizing similar types of options for a construction project into an option set comprising one or more options such that any one of the options from the option set can be selected for use in a part of the construction project;
assigning an option set to a room structure to define the possible options for the room structure, the room structure comprising an organizational unit representing a location related to a specific project or project template; and
generating a spec sheet that defines a building project in response to the assignment of one or more room structures to the spec sheet.

19. The method of claim 18, wherein the method further comprises generating a spec sheet template that defines a building project in response to the assignment of one or more room structures to the spec sheet template.

20. The method of claim 18, further comprising allowing a customer to select options car from the option set assigned to the room structure to specify the option to be used a construction project.
